(19) United States
(12) Patent Application Publication
(10) Pub. No.: US 2025/0098675 A1
(43) Pub. Date: Mar. 27, 2025

(54) A METHOD OF CONTROLLING RESISTANT AND NON-RESISTANT PESTS

(71) Applicants: UPL CORPORATION LIMITED, Port Louis (MU); UPL EUROPE LTD., Cheshire (GB); Mitsui Chemicals Crop & Life Solutions Inc, Tokyo (JP)

(72) Inventor: Gustavo Rodrigues Gonella LUIS, Tatui SP (BR)

(21) Appl. No.: 18/704,216

(22) PCT Filed: Oct. 27, 2022
(86) PCT No.: PCT/IB2022/060336

§ 371 Date: Apr. 24, 2024

(30) Foreign Application Priority Data
Oct. 28, 2021 (IN) 202111049369

(51) Int. Cl. A01N 43/40; A01N 25/04; A01N 43/56; A01P 7/04

(52) U.S. Cl. CPC A01N 43/40; A01N 25/04; A01N 43/56; A01P 7/04

(57) ABSTRACT

The present disclosure relates to a method of preventing, controlling and inhibiting sugarcane pests. The present disclosure relates to a method of controlling pests in sugarcane fields by applying a combination/composition comprising a pyridylidene insecticide and one or more insecticides.

### FIELD OF THE INVENTION

The present invention relates to a method of preventing, controlling, and inhibiting sugarcane pests. Particularly, the present invention relates to a method of controlling pests in sugarcane fields by applying a combination/composition comprising a pyridylidene insecticide and one or more insecticides.

### BACKGROUND OF THE INVENTION

Sugarcane is an economically important crop across the world. Sugar is commercially produced from either sugar beet (Beta vulgaris) or sugarcane (Saccharum spp.). Demand for sugar and sugarcane by-products is persistently increasing exponentially in both domestic and industrial sectors daily. The top three countries by sugar consumption in 2019/2020 were India, the European Union, and China. Sugarcane is a tall-growing monocotyledonous crop that is cultivated in tropical and subtropical regions of the world. It is known primarily for its ability to store high concentrations of sucrose or sugar in the stem.

Sugarcane is not merely a significant sugar crop but also a resource for different agro-based industries. Sugarcane (Saccharum officinarum; Poaceae) is one of the world's largest beneficial crops. Between 2009 and 2019, global sugar consumption has increased by over 20 million metric tonnes, from 154 million metric tonnes to around 177.6 million metric tonnes. Brazil was the largest sugar producer at 737 million tonnes. The world production of sugar from sugarcane is approximately six times that from sugar beet, the other major source of sugar.

In addition to sugar production, the sugarcane crop is also used to produce ethanol, bagasse and molasses. Sugarcane also provides raw materials as basic resources for industries like paper and chipboard manufacturing. A yield loss in sugarcane due to insect pests ranges from 10% to 30%. Despite application of insecticides, pesticides, other chemicals, and different integrated pest management (IPM) techniques, an increase in tolerance and resistance of insects in sugarcane plantations against conventionally used insecticides is rampant.

Sugarcane yields have been rigorously abridged in various parts of world in view of persistent attacks by enormous number of insect pests and diseases, it is important to note that most of these pests have developed resistance to conventionally used insecticides. Arthropod pests consist of complexes of branch feeders, sap sucking insects (e.g., aphids, thrips, mealy bugs), root feeders (e.g., white grubs, stem borers), and spider mites. Changes in cropping patterns, advent of chemicals for insect control have been providing new opportunities for reduction of crop losses due to biotic pressures. Insect control is even more important as many viral diseases are transmitted by insects.

However, in recent times there has been a build-up of resistant pests, inefficacy of chemicals, restricted or banned usage of certain crop-protection chemicals, green factor which is driving the sugarcane industry in search of new sustainable solutions that will aim to produce high yields of sugarcane while protecting it from resistant pests. There has been a growing need for efficient solutions which reduce chemical application to environment while delivering exemplary insect control results. It is in this aspect, that the present invention provides a method of mitigating problems faced by the sugarcane industry and sugarcane producing lands.

### OBJECTS OF THE INVENTION

Thus, it is an object of the present invention to provide a method for control of insect pests in sugarcane plantations.

It is another object of the present invention to deliver a fool proof pesticidal solution to control insects in sugarcane plantations, wherein the insect pests have become resistant to conventionally used insecticides.

It is yet another object of the present invention to provide a method of controlling insect pests in sugarcane plantations by applying an insecticide of high efficacy which when applied at lower doses liberates sugarcane from damaging insect pests while ensuring eco-friendliness.

It is also an object of the present invention to increase the yield of sugarcane by providing an effective insecticidal solution.

### SUMMARY OF INVENTION

In an aspect of the present invention, there is provided a method of preventing, controlling, or inhibiting insect pests in sugarcane plantations comprising applying at a locus an insecticide with a nicotinic acetylcholine receptor (nAChR) competitive modulatory activity. The said insecticide is a pyridylidene compound. Preferably, the said insecticide is flupyrimin.

In another aspect, there is provided a method of preventing, controlling, or inhibiting insect pests in sugarcane plantations comprising applying at a locus a pyridylidene insecticide having nicotinic acetylcholine receptor (nAChR) competitive modulatory activity, wherein the said insect pests are resistant to conventionally used insecticides.

In another aspect, the present invention provides a method of preventing, controlling, or inhibiting insect pests in sugarcane plantations comprising applying at a locus a pyridylidene insecticide having nicotinic acetylcholine receptor (nAChR) competitive modulatory activity and an anthranilic diamide insecticide.

In another aspect, the present invention provides a method of preventing, controlling, or inhibiting insect pests in sugarcane plantations comprising applying at a locus a combination of flupyrimin and chlorantraniliprole.

Another aspect of the present invention provides a method of preventing, controlling, or inhibiting sugarcane insect pests comprising applying at a locus of a sugarcane crop, its part or a plant propagation material a composition comprising flupyrimin.

Another aspect of the present invention provides a method of preventing, controlling, or inhibiting sugarcane insect pests comprising applying at a locus of a sugarcane crop, its part or a plant propagation material a composition comprising flupyrimin and chlorantraniliprole.

In an aspect, the sugarcane insect pests may also include pests resistant to other conventionally used insecticides, preferably nicotinic acetylcholine receptor (nAChR) competitive modulators.

Yet another aspect of the present invention provides use of flupyrimin to prevent, control or inhibit resistant and non-resistant pests in sugarcane. Flupyrimin may be applied to the target locus as a composition and may additionally be combined with one or more agrochemically suitable excipients such as surfactants, additives, adjuvants and so forth.

An aspect, thus, provides a method of liberating the sugarcane crop from resistant and non-resistant pests of the sugarcane crop comprising applying flupyrimin at the target locus. The compositions comprising flupyrimin for the said use are also provided herein.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to. The term ‘plants’ refers to all physical parts of a plant, including seeds, seedlings, saplings, roots, tubers, stems, stalks, foliage and fruits.

The term “crop” refers to both, growing and harvested crops.

The term “locus” of a plant as used herein is intended to embrace the place on which the plants are growing, where the plant propagation materials of the plants are sown or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

To “control” or “controlling” means to inhibit, and/or supress the ability of the insect to grow and/or proliferate, or to limit insect related damage or loss in crop plants or denotes control and prevention of the insects. Controlling effects include all deviation from natural development, for example: killing, retardation, decrease in insect population.

The term ‘conventionally applied insecticides’ is referred to the insecticides that have been consistently applied to the plantations to inhibit, control or prevent insect infestation. However, the persistent use of such insecticides has raised incidences about pests having developed resistance to the said insecticides.

The term ‘dead hearts’ as referred to in the present invention denotes damage caused to young crops/plants as a result of infestation by an insect compromising the meristematic tissue of a plant resulting in the young crop/plant being pulled out easily. With reference to the present invention, the caterpillars of the shoot borer cause dead hearts in young plants. The young plants with dead hearts formed at shoot stage can be pulled out easily.

Accordingly, the conventionally used insecticides include that the insects may be resistant to are selected from the group consisting of imidacloprid, thiamethoxam, dinetofuran, clothianidin, acetamiprid, nitenpyram, thiacloprid, flupyradifurone, sulfoxaflor and triflumezopyrim.

Neonicotinoids and other nicotinic acetylcholine receptor (nAChR) modulators have been a farmer's preferred choice for controlling pests in the field, for their sheer efficacy and wide range of target pests. However, recently many incidences about pests having developed resistance to chemicals belonging to the said group are being reported. Pest resistance is becoming an increasing problem for agriculture practitioners and the fraternity is being increasingly rigged with a ban on pesticides, abolishment of chemicals, regulatory barricades, and paucity of bio-solutions with equivalent efficacy as of chemical pesticides.

In a pursuit of solutions to overcome the above challenges, the inventors of the present invention have found to their surprise, an effective way of controlling pests widely spread in sugarcane, particularly resistant varieties by applying flupyrimin to the locus. The inventors of the present invention have observed the efficacy with which the new active resistant as well as non-resistant varieties of pests in the sugarcane crop have been controlled using the present method.

The inventors of the present invention have observed the efficacy of the combination of flupyrimin and chlorantraniliprole against new active resistant as well as non-resistant varieties of pests in the sugarcane crop has been unexpectedly found to be exceptional.

The embodiments stated below present this invention in the most elaborate way and exemplifies the veracity of the same. However, the embodiments and examples stated herein should not be construed limiting in any way and is a mere way of depicting few of the many aspects of the present invention.

In accordance with the above objectives, an embodiment of the present invention provides a method of preventing, controlling, or inhibiting sugarcane pests comprising applying at a locus an insecticide with nicotinic acetylcholine receptor (nAChR) competitive modulatory activity.

In an embodiment, the present invention provides an insecticide combination comprising a pyridylidene insecticide, particularly flupyrimin and one or more insecticides for preventing, controlling, or inhibiting insect pests in sugarcane plantations.

In an embodiment, the present invention provides an insecticide combination comprising a pyridylidene insecticide, particularly flupyrimin and one or more insecticides for preventing, controlling, or inhibiting insect pests in sugarcane plantations, wherein the said insects are resistant to conventionally used insecticides.

The pyridylidene compound that is flupyrimin or agriculturally acceptable salts, n-oxide, co-crystal, solvate, esters, enantiomers or diastereomers, mixtures of different crystalline states as well as amorphous or crystalline salts thereof.

In an embodiment, the present invention provides a combination comprising a pyridylidene insecticide and an insecticide selected from the group comprising carbamates, organophosphates, cyclodiene organochlorines, phenylpyrazoles, pyrethroids, pyrethrins, neonicotinoids, sulfoximines, butenolides, mesoionics, pyridylidenes, spinosyns, avermectins, milbemycins, alkylhalides, fluorides, borates, oxadiazines, semicarbazones, benzoylureas, diacylhydrazines, pyridine azomethine derivatives, pyropenes, phosphides, cyanides, diamides, meta-diamides and isoxazolines.

In an embodiment, the ryanodine receptor modulator is a diamide insecticide.

In an embodiment, the diamide insecticide is selected from the group comprising chlorantraniliprole, cyantraniliprole, cyclaniliprole, flubendiamide and tetraniliprole.

In an embodiment, the diamide insecticide is an anthranilic diamide insecticide.

In an embodiment, the anthranilic diamide insecticide is chlorantraniliprole and cyantraniliprole.

In an embodiment, the present invention provides an insecticide combination comprising flupyrimin and chlorantraniliprole.

In an embodiment, the present invention provides an insecticide combination comprising flupyrimin and cyantraniliprole.

In an embodiment, the present invention provides an insecticide combination comprising a pyridylidene insecticide and a diamide insecticide, wherein the ratio of the pyridylidene insecticide and the diamide insecticide is ranging from 1:100 to 100:1.

In another embodiment, the present invention provides an insecticide combination comprising a pyridylidene insecticide and a diamide insecticide, wherein the ratio of the pyridylidene insecticide and the diamide insecticide is ranging from 1:80 to 80:1, preferably from 1:50 to 50:1, more preferably from 1:30 to 30:1 and mostly preferably from 1:20 to 20:1.

In an embodiment, the present invention provides an insecticide combination comprising a pyridylidene insecticide and a diamide insecticide, wherein the ratio of the pyridylidene insecticide and the diamide insecticide is ranging from 1:10 to 10:1.

In a preferred embodiment, the present invention provides an insecticide combination comprising a pyridylidene insecticide and a diamide insecticide, wherein the ratio of the pyridylidene insecticide and the diamide insecticide is ranging from 1:5 to 5:1.

In a preferred embodiment, the present invention provides an insecticide combination comprising a pyridylidene insecticide and a diamide insecticide, wherein the ratio of the pyridylidene insecticide and the diamide insecticide is ranging from 1:2 to 2:1.

In an embodiment, the present invention provides a method of preventing, controlling or inhibiting sugarcane pests comprising applying at a locus a pyridylidene insecticide.

In an embodiment, the present invention provides a method of preventing, controlling or inhibiting sugarcane pests comprising applying at a locus a combination comprising a pyridylidene insecticide and a diamide insecticide.

According to an embodiment, the said insecticide is a pyridylidene.

According to an embodiment, the said pyridylidene insecticide is flupyrimin.

The said insecticide is applied as a composition to the target locus.

In an embodiment, the diamide insecticide is selected from the group comprising chlorantraniliprole, cyantraniliprole, cyclaniliprole, flubendiamide and tetraniliprole.

In an embodiment, the diamide insecticide is an anthranilic diamide insecticide.

In an embodiment, the anthranilic diamide insecticide is chlorantraniliprole and cyantraniliprole.

In an embodiment, the present invention provides a method of preventing, controlling, or inhibiting sugarcane pests comprising applying at a locus a combination comprising flupyrimin and chlorantraniliprole.

In an embodiment, the individual components of the combination of the present invention may be applied to the locus either simultaneously or sequentially, such that flupyrimin and one or more pesticides, preferably chlorantraniliprole may be applied in a tank mix or as a pre-mixed composition.

According to an embodiment, there is provided a composition comprising a pyridylidene insecticide for preventing, controlling or inhibiting insect pests in sugarcane. In an embodiment, there is provided a composition comprising flupyrimin for preventing, controlling or eradicating pests in sugarcane.

According to an embodiment, the pests controlled by the compositions of the present invention may not be resistant to any insecticide.

In another embodiment, the pests controlled by the compositions of the present invention may be resistant to at least one insecticide.

The content of the pyridylidene insecticide in the composition may amount up to 99% by weight.

In an embodiment, the present invention provides an insecticidal composition comprising a pyridylidene insecticide for preventing, controlling, or inhibiting insect pests in sugarcane plantations.

In an embodiment, the present invention provides an insecticidal composition comprising a pyridylidene insecticide, wherein the pyridylidene insecticide is in a concentration ranging from 1% to 100% w/w, more preferably in a concentration ranging from 1% to 50 w/w.

In an embodiment, the present invention provides an insecticidal composition comprising a pyridylidene insecticide in a concentration ranging from 1% to 50% w/w.

In an embodiment, the present invention provides an insecticidal composition comprising flupyrimin in a concentration ranging from 1% to 50% w/w.

In an embodiment, the present invention provides an insecticidal suspension concentrate composition comprising flupyrimin in a concentration ranging from 1% to 50% w/w.

In an embodiment, the present invention provides an insecticidal flowable concentrate composition comprising flupyrimin in a concentration ranging from 1% to 50% w/w.

In an embodiment, the present invention provides an insecticidal flowable suspension concentrate composition comprising flupyrimin in a concentration ranging from 1% to 50% w/w.

In an embodiment, the present invention provides a granular composition comprising flupyrimin in a concentration ranging from 1% to 50% w/w.

In an embodiment, the present invention provides an insecticidal composition comprising a pyridylidene insecticide and a diamide insecticide.

According to an embodiment, the said insecticide is a pyridylidene.

According to an embodiment, the said pyridylidene insecticide is flupyrimin.

In an embodiment, the diamide insecticide is selected from the group comprising chlorantraniliprole, cyantraniliprole, cyclaniliprole, flubendiamide and tetraniliprole.

In an embodiment, the diamide insecticide is an anthranilic diamide insecticide.

In an embodiment, the anthranilic diamide insecticide is chlorantraniliprole and cyantraniliprole.

In an embodiment, the present invention provides an insecticidal composition comprising a pyridylidene insecticide and a diamide insecticide, wherein the pyridylidene insecticide is in a concentration ranging from 1% to 100% w/w and the diamide insecticide is in a concentration ranging from 1% to 100% w/w, preferably the pyridylidene insecticide is in a concentration ranging from 1% to 80% w/w and the diamide insecticide is in a concentration ranging from 1% to 80% w/w, more preferably the pyridylidene insecticide is in a concentration ranging from 1% to 50% w/w and the diamide insecticide is in a concentration ranging from 1% to 50% w/w.

In an embodiment, the present invention provides an insecticidal composition comprising a pyridylidene insecticide and a diamide insecticide, wherein the pyridylidene insecticide is in a concentration ranging from 1% to 35% w/w and the diamide insecticide is in a concentration ranging from 1% to 35% w/w.

In an embodiment, the present invention provides an insecticidal composition comprising a pyridylidene insecticide and a diamide insecticide, wherein the pyridylidene insecticide is in a concentration ranging from 1% to 20% w/w and the diamide insecticide is in a concentration ranging from 1% to 20% w/w.

In an embodiment, the present invention provides an insecticidal composition comprising a flupyrimin and chlorantraniliprole, wherein flupyrimin is in a concentration ranging from 1% to 20% w/w and chlorantraniliprole is in a concentration ranging from 1% to 20% w/w.

In an embodiment, the present invention provides an insecticidal granular composition comprising a pyridylidene insecticide and a diamide insecticide, wherein the pyridylidene insecticide is in a concentration ranging from 1% to 20% w/w and the diamide insecticide is in a concentration ranging from 1% to 20% w/w.

In an embodiment, the present invention provides an insecticidal granular composition comprising a flupyrimin and chlorantraniliprole, wherein flupyrimin is in a concentration ranging from 1% to 20% w/w and chlorantraniliprole is in a concentration ranging from 1% to 20% w/w.

In a preferred embodiment, the present invention provides an insecticidal composition comprising flupyrimin and chlorantraniliprole, wherein flupyrimin is in a concentration ranging from 10% to 20% w/w and chlorantraniliprole is in a concentration ranging from 10% to 20% w/w.

According to an embodiment of the present invention, there is provided a composition for preventing, controlling or eradicating pests in sugarcane plantations, wherein said composition comprises a pyridylidene insecticide and an agrochemically suitable excipient.

In an embodiment of the present invention, there is provided a composition for preventing, controlling or inhibiting pests in sugarcane in plantations, wherein the said composition comprises flupyrimin and an agrochemically suitable excipient.

In an embodiment of the present invention, there is provided a composition for preventing, controlling or inhibiting pests in sugarcane plantations, wherein the said composition comprises flupyrimin, an additional insecticide and an agrochemically suitable excipient, wherein the additional insecticide is chlorantraniliprole.

For the present invention, the agrochemically suitable excipient carrier may be any one or a combination of adjuvants, co-solvents, surfactants, colorants, emulsifiers, thickeners, antifreeze agents, biocides, anti-foam agents, stabilizers, wetting agents or a mixture thereof which may be optionally added to the compositions of the present invention.

The surfactants may be selected from non-ionic, anionic or cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

Emulsifiers which can be advantageously employed herein can be readily determined by those skilled in the art and include various non-ionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable & Animal Fats, Vegetable & Animal Fats Sulfate, Vegetable & Animal Oil, Vegetable & Animal Oil Sulfate, Vegetable & Animal Wax, Vegetable & Animal Wax Sulfate, agents based on silicon or magnesium stearate.

Representative organic liquids which can be employed in preparing the emulsifiable concentrates of the present invention are the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of the emulsifiable concentrate. The formulations can also contain other compatible additives, for example, plant growth regulators and other biologically active compounds used in agriculture.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

The agrochemical formulation may also comprise one or more antioxidants. Preferably, the agrochemical formulation comprises an antioxidant. Antioxidants are, for example, amino acids (e.g. glycine, histidine, tyrosine, tryptophan) and derivatives thereof, imidazole and imidazole derivatives (e.g. urocanic acid), peptides, such as, for example, D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and further thio compounds (e.g. thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, Y-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol/kg to pmol/kg), also metal chelating agents (e.g. α-hydroxy fatty acids, EDTA, EGTA, phytic acid, lactoferrin), α-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g. tocopheryl acetate, linoleate, oleate and succinate, tocophereth-5, tocophereth-10, tocophereth-12, tocophereth-18, tocophereth-50, tocophersolan), vitamin A and derivatives (e.g. vitamin A palmitate), the coniferyl benzoate of benzoin resin, rutin, rutinic acid and derivatives thereof, disodium rutinyl disulfate, cinnamic acid and derivatives thereof (e.g. ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g. stilbene oxide, trans-stilbene oxide). According to the invention, suitable derivatives (salts, esters, sugars, nucleotides, nucleosides, peptides and lipids) and mixtures of these specified active ingredients or plant extracts (e.g. teatree oil, rosemary extract and rosemarinic acid) which comprise these antioxidants can be used. In general, mixtures of the aforementions antioxidants are possible.

According to an embodiment, examples of suitable solvents are water, aromatic solvents (for example Solvesso products, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, suitable surfactants are alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

According to an embodiment, examples of suitable carriers are mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.

Suitable preservatives are for example 1,2-benzisothiazolin-3-one and/or 2-Methyl-2H-isothiazol-3-one or sodium benzoate or benzoic acid.

In an embodiment, the concentration of the agrochemically suitable excipient ranges from 0.1 to 99% of the weight of the composition.

The compositions of this invention may be formulated as solid or liquid. Concentrated formulations can be dispersed in water, or another liquid, for application, or formulations can be dust-like or granular. The formulations are prepared according to procedures which are conventional in the agricultural chemical art, but which are novel and important because of the presence therein of a composition. The formulations that are applied most often are aqueous suspensions or emulsions. Either such water-soluble, water-suspendable, or emulsifiable formulations are solids, usually known as wettable powders, or liquids, usually known as emulsifiable concentrates, aqueous suspensions, or suspension concentrates. The present disclosure contemplates all vehicles by which the compositions can be formulated for delivery and use as an insecticide.

The compositions of the present invention may also be formulated as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra-low volume (ULV) liquid, ultra-low volume (ULV) suspension, water dispersible granules or tablets, water dispersible powder for slurry treatment, water soluble granules or tablets, water soluble powder for seed treatment and wettable powder.

More specifically, the compositions are formulated as solutions, emulsions, suspensions, dusts, powders, pastes, granules, pressings, capsules, wettable powders, soluble (liquid) concentrates, suspension concentrates, oil in water emulsion, water in oil emulsion, emulsifiable concentrates, capsule suspensions, ZC formulations, liquid creame (FC) formulation, oil dispersions and mixtures thereof.

Non-limiting examples for composition types are suspensions (e. g. SC, OD, FS), emulsifiable concentrates (e. g. EC), emulsions (e. g. EW, EO, ES, ME), capsules (e. g. CS, ZC), pastes, pastilles, wettable powders or dusts (e. g. WP, SP, WS, DP, DS), pressings (e. g. BR, TB, DT), granules (e. g. WG, SG, GR, FG, GG, MG), insecticidal articles (e. g. LN), as well as gel formulations for the treatment of plant propagation materials such as seeds (e. g. GF).

The compounds and mixtures according to the invention are suitable for use in treatment of sugarcane crop. Solutions for seed treatment (LS), Suspo-emulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds.

The compositions of the present invention may further comprise one or more additional insecticides for pest control.

Non-limiting examples of insecticides are selected from: Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, Xylylcarb, Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, Vamidothion, Chlordane, Endosulfan, Ethiprole, Fipronil, Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin, DDT, Methoxychlor, Acetamiprid, Clothianidin, Dinotefuran, Imidacloprid, Nitenpyram, Thiacloprid, Thiamethoxam, Nicotine, Sulfoxaflor, Flupyradifurone, Triflumezopyrim, Spinetoram, Spinosad, Abamectin, Emamectin benzoate, Lepimectin, Milbemectin, Hydroprene, Kinoprene, Methoprene, Fenoxycarb, Pyriproxyfen, Methyl bromide and other alkyl halides, Chloropicrin, Cryolite (Sodium aluminum fluoride), Sulfuryl fluoride, Borax, Boric acid, Disodium octaborate, Sodium borate, Sodium metaborate, Tartar emetic, Dazomet, Metam, Pymetrozine, Pyrifluquinazon, Afidopyropen, Clofentezine, Diflovidazin, Hexythiazox, Etoxazole, Bacillus subsp. Israelensis, Bacillus thuringiensis subsp. Aizawai, Bacillus thuringiensis subsp. Kurstaki, Bacillus thuringiensis subsp. Tenebrionis, B.t. crop proteins: (* Please see footnote) CrylAb, CrylAc, CrylFa, CrylA.105, Cry2Ab, Vip3A, mCry3A, Cry3Ab, Cry3Bb, Cry34Ab1/Cry35Ab1, Bacillus sphaericus, Diafenthiuron, Azocyclotin, Cyhexatin, Fenbutatin oxide, Propargite, Tetradifon, Chlorfenapyr, DNOC, Sulfluramid, Bensultap, Cartap hydrochloride, Thiocyclam, Thiosultap-sodium, Bistrifluron, Chlorfluazuron, Diflubenzuron, Flucycloxuron, Flufenoxuron, Hexaflumuron, Lufenuron, Novaluron, Noviflumuron, Teflubenzuron, Triflumuron, Buprofezin, Cyromazine, Chromafenozide, Halofenozide, Methoxyfenozide, Tebufenozide, Amitraz, Hydramethylnon, Acequinocyl, Fluacrypyrim, Bifenazate, Fenazaquin, Fenpyroximate, Pyridaben, Pyrimidifen, Tebufenpyrad, Tolfenpyrad, Rotenone (Derris), Indoxacarb, Metaflumizone, Spirodiclofen, Spiromesifen, Spiropidion, Spirotetramat, Aluminium phosphide, Calcium phosphide, Phosphine, Zinc phosphide, Calcium cyanide, Potassium cyanide, Sodium cyanide, Cyenopyrafen, Cyflumetofen, Pyflubumide, Chlorantraniliprole, Cyantraniliprole, Cyclaniliprole Flubendiamide, Tetraniliprole, Flonicamid, Broflanilide, Fluxametamide, Cydia pomonella GV, Thaumatotibia leucotreta GV, Anticarsia gemmatalis MNPV, Helicoverpa armigera NPV, GS-omega/kappa HXTX-Hv1a peptide, Azadirachtin, Benzoximate, Bromopropylate, Chinomethionat, Dicofol, Lime sulfur, Mancozeb, Pyridalyl, Sulfur, Burkholderia spp, Wolbachia pipientis (Zap), Chenopodium ambrosioides near ambrosioides extract, Fatty acid monoesters with glycerol or propanediol Neem oil, Beauveria bassiana strains, Metarhizium anisopliae strain F52, Paecilomyces fumosoroseus Apopka strain 97, Diatomaceous earth.

According to an embodiment, there is provided a composition for preventing, controlling or inhibiting pests in sugarcane comprising a pyridylidene insecticide and an additional insecticide.

According to an embodiment, the said additional insecticide is selected from the group consisting of chlorantraniliprole, cyantraniliprole, bifenthrin, ethiprole, cypermethrin, alpha-cypermethrin, acetamiprid and combinations thereof.

According to the above embodiments, the said pyridylidene insecticide is flupyrimin.

In an embodiment, the composition of the present invention is applied directly and/or indirectly to the plant and/or to plant propagation material by drenching the soil, by drip application onto the soil, by soil injection, by dipping or by treatment of seeds.

The pyridylidene insecticide is applied at a rate of 50 to 1000 gai/ha. The said insecticide may be applied in multiple rounds during the crop cycle.

The compositions of the present invention may be conveniently prepared in concentrated form or in a ready-to-use form.

According to an embodiment of the present disclosure, a kit-of-parts comprising an agrochemical composition is provided. The kit comprises a plurality of components, each of which components may include at least one of the ingredients of the agrochemical composition of the present disclosure.

An embodiment of the present invention discloses a kit-of-parts comprising an agrochemical composition of flupyrimin and optionally at least one additional active ingredient and/or agrochemically acceptable excipient.

An embodiment of the present invention discloses a kit-of-parts comprising an agrochemical composition of flupyrimin, chlorantraniliprole and/or agrochemically acceptable excipient.

In one embodiment of the present disclosure, the kits may include one or more, including all, components that may be used to prepare the agrochemical composition e. g., kits may include pyridylidene insecticide, another insecticide and agrochemically acceptable excipient.

In one embodiment of the present disclosure, the kits may include one or more, including all, components that may be used to prepare the agrochemical composition e. g., kits may include pyridylidene insecticide, a diamide insecticide and agrochemically acceptable excipient

One or more of the components may already be combined or pre-formulated. In those embodiments where more than two components are provided in a kit, the components may already be combined and as such are packaged in a single container such as a vial, bottle, can, pouch, bag, or canister.

The present compositions can be applied to a locus by the use of conventional ground sprayers, granule applicators, watering (drenching), drip irrigation, in furrow application, spraying, atomizing, broadcasting, dusting, foaming, spreading-on, granular application, aerial methods of spraying, aerial methods of application, side dressing, spot application, ring application, root zone application, pralinage, seedling root dip, sett treatment, trunk/stem injection, padding, swabbing, root feeding, soil drenching, capsular placement, baiting, fumigation, banding, foliar application, basal application, space treatment, enclosed space fumigation, methods utilizing application using modern technologies such as, but not limited to, drones, robots, predosage device, a knapsack sprayer, a spray tank, a spray plane, or an irrigation system and by such other conventional means known to those skilled in the art.

Another embodiment of the present invention provides a method of preventing, controlling or eradicating sugarcane pests comprising applying flupyrimin to a locus.

Another embodiment of the present invention provides a method of preventing, controlling or eradicating sugarcane pests comprising applying to a locus a composition comprising flupyrimin.

Non-limiting examples of pests against which the compositions of the present invention are effective against are:
pests from the phylum Arthropoda, especially from the class Arachnida, for example, Acarus spp., Aceria sheldoni, Aculops spp., Aculus spp., Amblyomma spp., Amphitetranychus viennensis, Argas spp., Boophilus spp., Brevipalpus spp., Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., Epitrimerus pyri, Eutetranychus spp., Eriophyes spp., Glycyphagus domesticus, Halotydeus destructor, Hemitarsonemus spp., Hyalomma spp., Ixodes spp., Latrodectus spp., Loxosceles spp., Metatetranychus spp., Neutrombicula autumnalis, Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., Tetranychus spp., Trombicula alfreddugesi, Vaejovis spp., Vasates lycopersici; from the class Chilopoda, for example, Geophilus spp., Scutigera spp.;
from the order or the class Collembola, for example, Onychiurus armatus;
from the class Diplopoda, for example, Blaniulus guttulatus;
from the class Insecta, e.g. from the order Blattodea, for example, Blattella asahinai, Blattella germanica, Blatta orientalis, Leucophaea maderae, Panchlora spp., Parcoblatta spp., Periplaneta spp., Supella longipalpa;
from the order Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptolestes ferrugineus, Cryptorhynchus lapathi, Cylindrocopturus spp., Dermestes spp., Diabrotica spp., Dichocrocis spp., Dicladispa armigera, Diloboderus spp., Epilachna spp., Epitrix spp., Faustinus spp., Gibbium psylloides, Gnathocerus cornutus, Hellula undalis, Heteronychus arator, Heteronyx spp., Hylamorpha elegans, Hylotrupes bajulus, Hypera postica, Hypomeces squamosus, Hypothenemus spp., Lachnosterna consanguinea, Lasioderma serricorne, Latheticus oryzae, Lathridius spp., Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Necrobia spp., Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllophaga helleri, Phyllotreta spp., Popillia japonica, Premnotrypes spp., Prostephanus truncatus, Psylliodes spp., Ptinus spp., Rhizobius ventralis, Rhizopertha dominica, Sitophilus spp., Sitophilus oryzae, Sphenophorus spp., Stegobium paniceum, Sternechus spp., Symphyletes spp., Tanymecus spp., Tenebrio molitor, Tenebrioides mauretanicus, Tribolium spp., Trogoderma spp., Tychius spp., Xylotrechus spp., Zabrus spp.;
from the order Diptera, for example, Aedes spp., Agromyza spp., Anastrepha spp., Anopheles spp., Asphondylia spp., Bactrocera spp., Bibio hortulanus, Calliphora erythrocephala, Calliphora vicina, Ceratitis capitata, Chironomus spp., Chrysomyia spp., Chrysops spp., Chrysozona pluvialis, Cochliomyia spp., Contarinia spp., Cordylobia anthropophage, Cricotopus sylvestris, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hydrellia griseola, Hylemya spp., Hippobosca spp., Hypoderma spp., Liriomyza spp., Lucilia spp., Lutzomyia spp., Mansonia spp., Musca spp., Oestrus spp., Oscinella frit, Paratanytarsus spp., Paralauterborniella subcincta, Pegomyia spp., Phlebotomus spp., Phorbia spp., Phormia spp., Piophila casei, Prodiplosis spp., Psila rosae, Rhagoletis spp., Sarcophaga spp., Simulium spp., Stomoxys spp., Tabanus spp., Tetanops spp., Tipula spp.;
from the order Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptocorisa varicornis, Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.;
from the order Homoptera, for example, Acizzia acaciaebaileyanae, Acizzia dodonaeae, Acizzia uncatoides, Acrida turrita, Acyrthosipon spp., Acrogonia spp., Aeneolamia spp., Agonoscena spp., Aleyrodes proletella, Aleurolobus barodensis, Aleurothrixus floccosus, Allocaridara malayensis, Amrasca spp., Anuraphis cardui, Aonidiella spp., Aphanostigma piri, Aphis spp., Arboridia apicalis, Arytainilla spp., Aspidiella spp., Aspidiotus spp., Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., Calligypona marginata, Carneocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus ficus, Cicadulina mbila, Coccomytilus halli, Coccus spp., Cryptomyzus ribis, Cryptoneossa spp., Ctenarytaina spp., Dalbulus spp., Dialeurodes citri, Diaphorina citri, Diaspis spp., Drosicha spp., Dysaphis spp., Dysmicoccus spp., Empoasca spp., Eriosoma spp., Erythroneura spp., Eucalyptolyma spp., Euphyllura spp., Euscelis bilobatus, Ferrisia spp., Geococcus coffeae, Glycaspis spp., Heteropsylla cubana, Heteropsylla spinulosa, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Macrosteles facifrons, Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nettigoniclla spectra, Nilaparvata lugens, Oncometopia spp., Orthezia praelonga, Oxya chinensis, Pachypsylla spp., Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Prosopidopsylla flava, Protopulvinaria pyriformis, Pseudaulacaspis pentagona, Pseudococcus spp., Psyllopsis spp., Psylla spp., Pteromalus spp., Pyrilla spp., Quadraspidiotus spp., Quesada gigas, Rastrococcus spp., Rhopalosiphum spp., Saissetia spp., Scaphoideus titanus, Schizaphis graminum, Selenaspidus articulatus, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., Trialeurodes vaporariorum, Trioza spp., Typhlocyba spp., Unaspis spp., Viteus vitifolii, Zygina spp.;
from the order Hymenoptera, for example, Acromyrmex spp., Athalia spp., Atta spp., Diprion spp., Hoplocampa spp., Lasius spp., Monomorium pharaonis, Sirex spp., Solenopsis invicta, Tapinoma spp., Urocerus spp., Vespa spp., Xeris spp.;
from the order Isopoda, for example, Armadillidium vulgare, Oniscus asellus, Porcellio scaber;
from the order Isoptera, for example, Coptotermes spp., Cornitermes cumulans, Cryptotermes spp., Incisitermes spp., Microtermes obesi, Odontotermes spp., Reticulitermes spp.;
from the order Lepidoptera, for example, Achroia grisella, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., Choristoneura spp., Clysia ambiguella, Cnaphalocerus spp., Cnaphalocrocis medinalis, Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamstra brassicae, Melanitis leda, Mocis spp., Monopis obviella, Mythimna separata, Nemapogon cloacellus, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudaletia unipuncta, Pseudoplusia includens, Pyrausta nubilalis, Rachiplusia nu, Schoenobius spp., Scirpophaga spp., Scirpophaga innotata, Scotia segetum, Sesamia spp., Sesamia inferens, Sparganothis spp., Spodoptera spp. (Fall Armyworm), Spodoptera praefica, Spodoptera frugiperda, Stathmopoda spp., Stomopteryx subsecivella, Synanthedon spp., Tecia solanivora, Thermesia gemmatalis, Tinea cloacella, Tinea pellionella, Tineola bisselliella, Tortrix spp., Trichophaga tapetzella, Trichoplusia spp., Tryporyza incertulas, Tuta absoluta, Virachola spp.;
from the order Orthoptera or Saltatoria, for example, Acheta domesticus, Dichroplus spp., Gryllotalpa spp., Hieroglyphus spp., Locusta spp., Melanoplus spp., Schistocerca gregaria;
from the order Phthiraptera, for example, Damalinia spp., Haematopinus spp., Linognathus spp., Pediculus spp., Ptirus pubis, Trichodectes spp.;
from the order Psocoptera for example Lepinatus spp., Liposcelis spp.;
from the order Siphonaptera, for example, Ceratophyllus spp., Ctenocephalides spp., Pulex irritans, Tunga penetrans, Xenopsylla cheopsis;
from the order Thysanoptera, for example, Anaphothrips obscurus, Baliothrips biformis, Drepanothrips reuteri, Enneothrips flavens, Frankliniella spp., Heliothrips spp., Hercinothrips femoralis, Rhipiphorothrips cruentatus, Scirtothrips spp., Taeniothrips cardamomi, Thrips spp.;
from the order Zygentoma (Thysanura), for example, Ctenolepisma spp., Lepisma saccharina, Lepismodes inquilinus, Thermobia domestica;
from the class Symphyla, for example, Scutigerella spp.;
pests from the phylum Mollusca, especially from the class Bivalvia, for example, Dreissena spp., and from the class Gastropoda, for example, Anion spp., Biomphalaria spp., Bulinus spp., Deroceras spp., Galba spp., Lymnaea spp., Oncomelania spp., Pomacea spp., Succinea spp.;

animal pests from the phylums Plathelminthes and Nematoda, for example, Ancylostoma duodenale, Ancylostoma ceylanicum, Acylostoma braziliensis, Ancylostoma spp., Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti; phytoparasitic pests from the phylum Nematoda, for example, Aphelenchoides spp., Bursaphelenchus spp., Ditylenchus spp., Globodera spp., Heterodera spp., Longidorus spp., Meloidogyne spp., Pratylenchus spp., Radopholus spp., Trichodorus spp., Tylenchulus spp., Xiphinema spp., Helicotylenchus spp., Tylenchorhynchus spp., Scutellonema spp., Paratrichodorus spp., Meloinema spp., Paraphelenchus spp., Aglenchus spp., Belonolaimus spp., Nacobbus spp., Rotylenchulus spp., Rotylenchus spp., Neotylenchus spp., Paraphelenchus spp., Dolichodorus spp., Hoplolaimus spp., Punctodera spp., Criconemella spp., Quinisulcius spp., Hemicycliophora spp., Anguina spp., Subanguina spp., Hemicriconemoides spp., Psilenchus spp., Pseudohalenchus spp., Criconemoides spp., Cacopaurus spp., Hirschmaniella spp, Tetylenchus spp.

Other pests such as wireworms, for example, Agroites spp., Limonius spp., Elateridae spp., Aeolus spp., Conoderus spp., Melanotus spp., Dalopius spp. Tenebrionidae spp., Hypnoidus spp., Eleodes spp.

In a preferred embodiment, the method of the present invention is particularly effective against Sphenophorus levis, Diatraea saccharalis, Telchin licus, Heterotermes tenuis, Mahanarva fimbriolata, Migdolus fryanus, and Holotrichia serrata.

In an embodiment, the plant propagation material may include seeds, bulbs, corms, tubers, rhizomes, callus, leaflets, leaves, stems, grafts, cuttings, buds, seed pieces, grains, suckers, fruits, cut shoots and plantlets.

In another embodiment, there is provided a method of preventing, controlling or eradicating sugarcane pests comprising applying at a locus a pyridylidene insecticide having nicotinic acetylcholine receptor (nAChR) competitive modulatory activity.

In another embodiment, there is provided a method of preventing, controlling or eradicating sugarcane pests comprising applying at a locus a pyridylidene insecticide having nicotinic acetylcholine receptor (nAChR) competitive modulatory activity, wherein the said pests are resistant to other insecticides.

In another embodiment, there is provided a method of preventing, controlling or eradicating sugarcane pests comprising applying flupyrimin at a locus of a plant, plant part or plant propagation material, wherein the said pests are resistant to other insecticides.

In another embodiment, there is provided a method of preventing, controlling, inhibiting or eradicating sugarcane pests comprising applying flupyrimin or its agriculturally acceptable salts, n-oxide, co-crystal, solvate, esters, enantiomers or diastereomers, mixtures of different crystalline states as well as amorphous or crystalline salts thereof at a locus of a plant, plant part or plant propagation material, wherein the said pests are resistant to other insecticides.

In another embodiment, there is provided a method of preventing, controlling, inhibiting or eradicating Sphenophorus levis sugarcane pests comprising applying flupyrimin or its agriculturally acceptable salts at a locus of a plant, plant part or plant propagation material.

In another embodiment, there is provided a method of preventing, controlling, inhibiting or eradicating Chilo infuscatellus sugarcane pests comprising applying flupyrimin or its agriculturally acceptable salts at a locus of a plant, plant part or plant propagation material.

In another embodiment, there is provided a method of preventing, controlling, inhibiting or eradicating Mahanarva fimbriolata sugarcane pests comprising applying flupyrimin or its agriculturally acceptable salts at a locus of a plant, plant part or plant propagation material.

In another embodiment, there is provided a method of preventing, controlling or eradicating sugarcane pests comprising applying flupyrimin at a locus, wherein the said pests are not resistant to other insecticides.

The said pests may be pests resistant to other insecticides, preferably other nicotinic acetylcholine receptor (nAChR) competitive modulators.

The said pests may show resistance to insecticides selected from the group consisting of Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, Xylylcarb, Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, Vamidothion, Chlordane, Endosulfan, Ethiprole, Fipronil, Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambda Cyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin, DDT, Methoxychlor, Acetamiprid, Clothianidin, Dinotefuran, Imidacloprid, Nitenpyram, Thiacloprid, Thiamethoxam, Nicotine, Sulfoxaflor, Flupyradifurone, Triflumezopyrim, Spinetoram, Spinosad, Abamectin, Emamectin benzoate, Lepimectin, Milbemectin, Hydroprene, Kinoprene, Methoprene, Fenoxycarb, Pyriproxyfen, Methyl bromide and other alkyl halides, Chloropicrin, Cryolite (Sodium aluminum fluoride), Sulfuryl fluoride, Borax, Boric acid, Disodium octaborate, Sodium borate, Sodium metaborate, Tartar emetic, Dazomet, Metam, Pymetrozine, Pyrifluquinazon, Afidopyropen, Clofentezine, Diflovidazin, Hexythiazox, Etoxazole, Diafenthiuron, Azocyclotin, Cyhexatin, Fenbutatin oxide, Propargite, Tetradifon, Chlorfenapyr, DNOC, Sulfluramid, Bensultap, Cartap hydrochloride, Thiocyclam, Thiosultap-sodium, Bistrifluron, Chlorfluazuron, Diflubenzuron, Flucycloxuron, Flufenoxuron, Hexaflumuron, Lufenuron, Novaluron, Noviflumuron, Teflubenzuron, Triflumuron, Buprofezin, Cyromazine, Chromafenozide, Halofenozide, Methoxyfenozide, Tebufenozide, Amitraz, Hydramethylnon, Acequinocyl, Fluacrypyrim, Bifenazate, Fenazaquin, Fenpyroximate, Pyridaben, Pyrimidifen, Tebufenpyrad, Tolfenpyrad, Rotenone (Derris), Indoxacarb, Metaflumizone, Spirodiclofen, Spiromesifen, Spiropidion, Spirotetramat, Aluminium phosphide, Calcium phosphide, Phosphine, Zinc phosphide, Calcium cyanide, Potassium cyanide, Sodium cyanide, Cyenopyrafen, Cyflumetofen, Pyflubumide, Chlorantraniliprole, Cyantraniliprole, Cyclaniliprole Flubendiamide, Tetraniliprole, Broflanilide, and Fluxametamide.

More particularly, the said pests may be resistant to one or more insecticides selected from the group consisting of imidacloprid, thiamethoxam, dinetofuran, clothianidin, acetamiprid, nitenpyram, thiacloprid, flupyradifurone, sulfoxaflor and triflumezopyrim.

In an embodiment, the said pests may be resistant to imidacloprid.

In an embodiment, the said pests may be resistant to thiamethoxam.

An embodiment of the present invention provides a use of flupyrimin to prevent, control or inhibit resistant and non-resistant pests in sugarcane.

According to an embodiment, the present invention provides a method of liberating sugarcane from resistant and non-resistant pests comprising applying flupyrimin at the target locus.

Flupyrimin is applied at a rate of 50 to 1000 gai/ha. The compositions comprising flupyrimin are applied at a rate of 50 to 2000 ml/ha. The compositions of the present invention may be applied in multiple rounds during the crop cycle.

According to an embodiment, there is provided a method of seed treatment for sugarcane, said method comprising applying a pyridylidene insecticide to the seed.

The term seed embraces seeds and plant propagules of all kinds including but not limited to true seeds, seed pieces, suckers, corms, bulbs, fruit, tubers, grains, cuttings, cut shoots, plantlets and the like.

The term seed treatment comprises all suitable seed treatment techniques known in the art, such as seed dressing, seed coating, seed dusting, seed soaking and seed pelleting.

According to an embodiment, there is provided a sugarcane seed treated with a pyridylidene insecticide. Also provided herein is a plant arising out of a seed treated with a pyridylidene insecticide.

In all the above embodiments, the said pyridylidene insecticide used for seed treatment is flupyrimin.

In an embodiment, the present invention provides a method of preventing, controlling, or inhibiting insect pests in sugarcane plantations comprising applying at a locus flupyrimin in a concentration ranging from 1 g ai/ha to 500 g ai/ha.

In an embodiment, the present invention provides a method of preventing, controlling, or inhibiting insect pests in sugarcane plantations comprising applying flupyrimin at a locus in a concentration ranging from 10 g ai/ha to 500 g ai/ha.

In an embodiment, the present invention provides a method of preventing, controlling, or inhibiting insect pests in sugarcane plantations comprising applying at a locus flupyrimin in a concentration ranging from 100 g ai/ha to 400 g ai/ha.

In an embodiment, the present invention provides a method of preventing, controlling, or inhibiting insect pests in sugarcane plantations comprising applying at a locus a composition of flupyrimin in a concentration ranging from 1 g ai/ha to 500 g ai/ha.

In an embodiment, the present invention provides a method of preventing, controlling, or inhibiting insect pests in sugarcane plantations comprising applying at a locus a suspension concentrate composition of flupyrimin in a concentration ranging from 1 g ai/ha to 500 g ai/ha.

In an embodiment, the present invention provides a method of preventing, controlling, or inhibiting insect pests in sugarcane plantations comprising applying at a locus a flowable concentrate composition of flupyrimin in a concentration ranging from 1 g ai/ha to 500 g ai/ha.

In an embodiment, the present invention provides a method of preventing, controlling, or inhibiting insect pests in sugarcane plantations comprising applying at a locus a flowable suspension composition of flupyrimin in a concentration ranging from 1 g ai/ha to 500 g ai/ha.

In an embodiment, the present invention provides a method of preventing, controlling, or inhibiting sugarcane pests comprising applying at a locus a combination comprising flupyrimin and chlorantraniliprole, wherein the ratio of flupyrimin and chlorantraniliprole is ranging from 1:10 to 10:1 and preferably from 1:5 to 5:1.

In an embodiment, the present invention provides a method of preventing, controlling, or inhibiting sugarcane pests comprising applying at a locus a combination comprising flupyrimin and chlorantraniliprole, wherein the ratio of flupyrimin and chlorantraniliprole is ranging from 1:2 to 2:1.

In an embodiment, the present invention provides a method of preventing, controlling, or inhibiting sugarcane pests comprising applying at a locus a combination comprising flupyrimin and cyantraniliprole.

In an embodiment, the present invention provides a method of preventing, controlling, or inhibiting sugarcane pests comprising applying at a locus a combination comprising flupyrimin and cyantraniliprole, wherein the ratio of flupyrimin and cyantraniliprole is ranging from 1:10 to 10:1 and preferably from 1:5 to 5:1.

In an embodiment, the present invention provides a method of preventing, controlling, or inhibiting sugarcane pests comprising applying at a locus a combination comprising flupyrimin and chlorantraniliprole, wherein the combination of flupyrimin and chlorantraniliprole is applied in a concentration ranging from 1 g ai/ha to 500 g ai/ha.

In an embodiment, the present invention provides a method of preventing, controlling, or inhibiting sugarcane pests comprising applying at a locus a combination comprising flupyrimin and chlorantraniliprole, wherein the combination of flupyrimin and chlorantraniliprole is applied in a concentration ranging from 10 g ai/ha to 500 g ai/ha.

In an embodiment, the present invention provides a method of preventing, controlling, or inhibiting sugarcane pests comprising applying at a locus a combination comprising flupyrimin and chlorantraniliprole, wherein the combination of flupyrimin and chlorantraniliprole is applied in a concentration ranging from 100 g ai/ha to 300 g ai/ha.

In an embodiment, the present invention provides a method of preventing, controlling, or inhibiting sugarcane pests comprising applying at a locus a composition comprising flupyrimin and chlorantraniliprole, wherein the composition of flupyrimin and chlorantraniliprole is applied in a concentration ranging from 1 g ai/ha to 500 g ai/ha.

In an embodiment, the present invention provides a method of preventing, controlling, or inhibiting sugarcane pests comprising applying at a locus a granular composition comprising flupyrimin and chlorantraniliprole, wherein the composition of flupyrimin and chlorantraniliprole is applied in a concentration ranging from 1 g ai/ha to 500 g ai/ha.

In an embodiment, the present invention provides a method of preventing, controlling, or inhibiting sugarcane pests comprising applying at a locus a combination comprising flupyrimin and cyantraniliprole, wherein the combination of flupyrimin and cyantraniliprole is applied in a concentration ranging from 1 g ai/ha to 500 g ai/ha.

In an embodiment, the present invention provides a method of preventing, controlling, or inhibiting sugarcane pests comprising applying at a locus a combination comprising flupyrimin and cyantraniliprole, wherein the combination of flupyrimin and cyantraniliprole is applied in a concentration ranging from 10 g ai/ha to 300 g ai/ha.

In an embodiment, the present invention provides a method of preventing, controlling, or inhibiting sugarcane pests comprising applying at a locus a combination comprising flupyrimin and cyantraniliprole, wherein the combination of flupyrimin and cyantraniliprole is applied in a concentration ranging from 100 g ai/ha to 300 g ai/ha.

In an embodiment, the present invention provides a method of preventing, controlling, or inhibiting sugarcane pests comprising applying at a locus a combination comprising flupyrimin and chlorantraniliprole, wherein the combination of flupyrimin and chlorantraniliprole is applied in a concentration ranging from 1 g ai/ha to 500 g ai/ha.

In an embodiment, the present invention provides a method of preventing, controlling, or inhibiting resistant sugarcane pests comprising applying at a locus a combination comprising flupyrimin and chlorantraniliprole, wherein the combination of flupyrimin and chlorantraniliprole is applied in a concentration ranging from 10 g ai/ha to 500 g ai/ha.

In an embodiment, the present invention provides a method of preventing, controlling, or inhibiting resistant sugarcane pests comprising applying at a locus a combination comprising flupyrimin and chlorantraniliprole, wherein the combination of flupyrimin and chlorantraniliprole is applied in a concentration ranging from 50 g ai/ha to 300 g ai/ha.

In an embodiment, the present invention provides a method of preventing, controlling, or inhibiting sugarcane, Chilo infuscatellus pests comprising applying at a locus a composition comprising flupyrimin and chlorantraniliprole, wherein the composition of flupyrimin and chlorantraniliprole is applied in a concentration ranging from 1 g ai/ha to 500 g ai/ha.

In an embodiment, the present invention provides a method of preventing, controlling, or inhibiting sugarcane, Mahanarva fimbriolata, pests comprising applying at a locus a composition comprising flupyrimin and chlorantraniliprole, wherein the composition of flupyrimin and chlorantraniliprole is applied in a concentration ranging from 1 g ai/ha to 500 g ai/ha.

In an embodiment, the present invention provides a method of preventing, controlling, or inhibiting sugarcane pests comprising applying at a locus a combination comprising flupyrimin and chlorantraniliprole, wherein flupyrimin is applied in a concentration ranging from 1 g ai/ha to 500 g ai/ha and chlorantraniliprole is applied in a concentration ranging from 1 g ai/ha to 500 g ai/ha.

In an embodiment, the present invention provides a method of preventing, controlling, or inhibiting sugarcane pests comprising applying at a locus a combination comprising flupyrimin and chlorantraniliprole, wherein flupyrimin is applied in a concentration ranging from 1 g ai/ha to 300 g ai/ha and chlorantraniliprole is applied in a concentration ranging from 1 g ai/ha to 300 g ai/ha.

In an embodiment, the present invention provides a method of preventing, controlling, or inhibiting sugarcane pests comprising applying at a locus a combination comprising flupyrimin and chlorantraniliprole, wherein flupyrimin is applied in a concentration ranging from 50 g ai/ha to 200 g ai/ha and chlorantraniliprole is applied in a concentration ranging from 50 g ai/ha to 200 g ai/ha.

In an embodiment, the present invention provides a method of preventing, controlling, or inhibiting resistant sugarcane pests comprising applying at a locus a combination comprising flupyrimin and chlorantraniliprole, wherein flupyrimin is applied in a concentration ranging from 1 g ai/ha to 500 g ai/ha and chlorantraniliprole is applied in a concentration ranging from 1 g ai/ha to 500 g ai/ha.

In an embodiment, the present invention provides a method of preventing, controlling, or inhibiting sugarcane pests comprising applying at a locus a combination comprising flupyrimin and chlorantraniliprole, wherein the combination of flupyrimin and chlorantraniliprole is applied in a concentration ranging from 150 g ai/ha and 75 g ai/ha respectively, to obtain at least 60% control at 7 DAA and atleast 75% control at 45 DAA.

In an embodiment, the present invention provides a method of preventing, controlling, or inhibiting sugarcane pests comprising applying at a locus a combination comprising flupyrimin and chlorantraniliprole, wherein the combination of flupyrimin and chlorantraniliprole is applied in a concentration ranging from 175 g ai/ha and 87.5 g ai/ha respectively to obtain at least 70% control at 7 DAA and atleast 85% control at 45 DAA.

In an embodiment, the present invention provides a method of preventing, controlling, or inhibiting sugarcane pests comprising applying at a locus a combination comprising flupyrimin and chlorantraniliprole, wherein the combination of flupyrimin and chlorantraniliprole is applied in a concentration ranging from 150 g ai/ha and 75 g ai/ha to obtain at least 60% control at 7 DAA and atleast 75% control at 30 DAA.

In an embodiment, the present invention provides use of flupyrimin for preventing, controlling, or inhibiting sugarcane insect pests in sugarcane cultivations.

In an embodiment, the present invention provides use of flupyrimin for preventing, controlling, or inhibiting resistant sugarcane insect pests in sugarcane cultivations.

In an embodiment, the present invention provides use of flupyrimin and an additional insecticide for preventing, controlling, or inhibiting sugarcane insect pests in sugarcane cultivations, wherein the said sugarcane insect pest is likely to be a resistant insect.

In an embodiment, the present invention provides use of flupyrimin and an additional insecticide, namely chlorantraniliprole for control and inhibition of Sphenophorus levis, Chilo infuscatellus, Diatraea saccharalis, Telchin licus, Heterotermes tenuis, Mahanarva fimbriolata, Migdolus fryanus, and Holotrichia serrata.

The insects controlled or inhibited by the method of the present invention may be in the larvae stage or are developed insect adults, that are likely resistant or partially resistant to conventionally applied insecticides.

According to the inventors of this invention, seeds treated with flupyrimin surprisingly demonstrated better results and pest control. An advantage of seed treatment of sugarcane with flupyrimin is better control of pests, both resistant and non-resistant varieties, at a lower dosage rate. It enables advantages such as cost effectiveness, safety to the environment due to low chemical usage and better yield of crop and crop health which were earlier prone to resistant pests and difficult to control.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and following examples, but by all embodiments and methods within the scope and spirit of the invention.

### EXAMPLES

### Example 1: Flupyrimin Suspension Concentrate Formulation

TABLE 1

| Sr. No. | Ingredients | Amount (%) |
|---|---|---|
| 1 | Flupyrimin | 41.67 |
| 2 | Naphthalene sulfonate condensate, | 3 |
| | sodium salt | |
| 3 | Acrylic copolymer solution | 3 |
| 4 | Propylene glycol | 5 |
| 5 | Water | Q.S. |
| | Total | 100 |

### Example 2: Efficacy of Flupyrimin Against Mahanarva fimbriolata

Trials were carried out in field to assess efficacy of flupyrimin against Mahanarva fimbriolata. Evaluation was done to check % control of nymphs and adult insects at intervals of 30 DAA and 60 DAA (for nymphs) and 7, 30 and 60 DAA (for adult insects). The efficacy was compared with standard insecticides thiamethoxam and ethiprole.

TABLE 2

| | | | Nymphs | | Adults | | |
|---|---|---|---|---|---|---|---|
| | Dose | Active | % Control | | % Control | | |
| | rate | Ingredient | 30 | 60 | 7 | 30 | 60 |
| Treatment | (ml/ha) | (g a.i./ha) | DAA | DAA | DAA | DAA | DAA |
| Untreated | 0 | 0 | 0 | 0 | 0 | 0 | 0 |
| Flupyrimin | 300 | 150 | 62 | 95 | 80 | 100 | 75 |
| Flupyrimin | 400 | 200 | 97 | 95 | 80 | 50 | 100 |
| Flupyrimin | 500 | 250 | 92 | 100 | 60 | 100 | 50 |
| Flupyrimin | 600 | 300 | 81 | 95 | 40 | 25 | 100 |
| Thiamethoxam | 1000 | 250 | 86 | 90 | 60 | 50 | 75 |
| Ethiprole | 2000 | 400 | 95 | 100 | 100 | 100 | 100 |

DAA: days after application

From the above table, it was evident that 200 gai/ha flupyrimin was able to control 97% nymphs at 30 DAA as against the standard. An application of 250 gai/ha of flupyrimin provided complete control of nymphs at the 60 DAA stage as compared to ethiprole which controls 100% nymphs when applied at a rate of 400 gai/ha. Likewise, for adult insects, 150 gai/ha controls 80% of insects at 7 DAA stage and 100% insects at 30 DAA stage while 200 gai/ha controls 100% insects at 60 DAA. Thus, it can be noted that flupyrimin was able to control nymphs and adult insects equally or more at rates lower than other insecticides.

### Example 3: Efficacy of Flupyrimin and Combination of Flupyrimin with Chlorantraniliprole Against Chilo infuscatellus

Field trials were carried out to check efficacy of flupyrimin and combination of flupyrimin with chlorantraniliprole against sugarcane early shoot borer (Chilo infuscatellus). A suspension concentrate consisting of flupyrimin and chlorantraniliprole (SC) formulation was used. The test samples were compared with efficacy of the combination of Fipronil 40%+Imidacloprid 40%. Flupyrimin and chlorantraniliprole were applied as premix as well as tank-mix.

TABLE 3

| | | % Sugarcane early shoot borer | | | | | | | |
|---|---|---|---|---|---|---|---|---|---|
| | Dose | (Chilo infuscatellus) % control | | | | | | | |
| | rate | Trial 1 | | | | Trial 2 | | | |
| | Active | 0 | 7 | 15 | 30 | 7 | 15 | 30 | 45 |
| Treatment | g a.i./ha | DAA | DAA | DAA | DAA | DAA | DAA | DAA | DAA |
| Untreated | — | 13.3 | [16.7] | [20.7] | [32.0] | [35.3] | [31.3] | [28.0] | [24.0] |
| Check | | | | | | | | | |
| CTPR + | 225 | 10.7 | 68.1 | 74.2 | 72.9 | 77.3 | 76.7 | 76.2 | 75 |
| Flupyrimin | (75 + 150) | | | | | | | | |
| (100 + 200 g/l | | | | | | | | | |
| premix) | | | | | | | | | |
| CTPR + | 262.5 | 13.3 | 75.9 | 80.6 | 79.2 | 85 | 83.1 | 83.3 | 80.6 |
| Flupyrimin | (87.5 + 175) | | | | | | | | |
| (100 + 200 g/l | | | | | | | | | |
| premix) | | | | | | | | | |
| CTPR + | 300 | 15.3 | 80.1 | 87 | 85.4 | 90.5 | 91.5 | 92.9 | 86.1 |
| Flupyrimin | (100 + 200) | | | | | | | | |
| (100 + 200 g/l | | | | | | | | | |
| premix) | | | | | | | | | |
| CTPR + | 75 + 150 | 14.7 | 63.9 | 67.6 | 70.8 | 77.3 | 74.4 | 73.8 | 69.4 |
| Flupyrimin − | | | | | | | | | |
| (200 + 100 g/l | | | | | | | | | |
| Tank Mix) | | | | | | | | | |
| CTPR + | 87.5 + 175 | 11.3 | 75.9 | 77.3 | 74.8 | 81 | 81 | 81 | 77.8 |
| Flupyrimin − | | | | | | | | | |
| (200 + 100 g/l | | | | | | | | | |
| Tank Mix) | | | | | | | | | |
| Flupyrimin | 200 | 13.3 | 67.6 | 70.9 | 68.5 | 73.5 | 74.4 | 71.4 | 69.4 |
| 10SC | | | | | | | | | |
| CTPR 200SC | 75 | 13.3 | 72.2 | 74.2 | 70.9 | 75.5 | 76.7 | 76.2 | 75 |
| Fipronil 40% + | 400 | 12 | 72.2 | 74.2 | 72.6 | 77.3 | 78.8 | 76.2 | 75 |
| Imidacloprid | | | | | | | | | |
| 40% | | | | | | | | | |

CTPR = Chlorantraniliprole, DAA = Days after application
ESB: early shoot borer

### Example 3: Efficacy of Flupyrimin on Resistant Insects Mahanarva fimbriolata

Trials were conducted to demonstrate the efficacy of flupyrimin on resistant Mahanarva fimbriolata. The sugarcane plants were sown under greenhouse in pots. Artificially, each pot was infested with 10 nymphs in 3rd/4th instar. Infestation was done 24 h before of application for insect acclimatization. The treatments were applied via drenching, after infestation. The assessments were made at 3 and 5 days after infestation in 4 replications.

TABLE 4

| | | Mortality (%) of | |
|---|---|---|---|
| | Dose rate | Nymphs-Resistant population | |
| | Active | % Mortality | |
| Treatment | g.a.i/ha | 0 DAA 3 DAI | 0 DAA 5 DAI |
| Untreated | 0 | 0 | 6 |
| Flupyrimin | 150 | 85 | 98 |
| Flupyrimin | 200 | 97 | 100 |
| Flupyrimin | 250 | 98 | 98 |
| Flupyrimin | 300 | 97 | 100 |
| Thiamethoxam | 250 | 23 | 25 |
| Ethiprole | 400 | 33 | 45 |

DAI: days after infestation

From table 3, it is evident that flupyrimin was effective in completely controlling resistant nymphs.

### Example 4: Efficacy of the Combination of Flupyrimin and Chlorantraniliprole

The efficacy of the premix combination of flupyrimin and chlorantraniliprole against Chilo infuscatellus (early shoot borer) in sugarcane cultivations was evaluated. A suspension concentration formulation of flupyrimin and chlorantraniliprole was applied (CTPR 60+Flupyrimin 200 SC). The application was made at an economic threshold (ETL) of 10% dead hearts of the early shoot borer and at 25-40 DAP by drip irrigation.

TABLE 5

| | | Active | Use | | | | | | | | | | |
|---|---|---|---|---|---|---|---|---|---|---|---|---|---|
| Tr. | | rate | Rate | Mean of Dead hearts counts (CHILZO) per plot | | | | | | | | | |
| No. | Treatment | (g Al/ha) | (g/ha) | 15 DAA | | 30 DAA | | 45 DAA | | 60 DAA | | 75 DAA | |
| T1 | UTC | NA | NA | 11.00 | a | 22.00 | a | 31.00 | a | 42.00 | a | 34.00 | a |
| T2 | CTPR + Flupyrimin | 295 | 1135 | 1.00 | g | 2.00 | h | 4.00 | h | 8.00 | g | 8.00 | g |
| T3 | CTPR + Flupyrimin | 325 | 1250 | 0.00 | h | 1.00 | i | 3.00 | i | 5.00 | i | 5.00 | i |
| T4 | CTPR + Flupyrimin | 360 | 1385 | 0.00 | h | 1.00 | i | 2.00 | j | 4.00 | j | 4.00 | J |

CTPR: Chlorantraniliprole
UTC: Untreated control

The caterpillars of the shoot borer cause dead hearts in young plants. The young plants with dead hearts formed at shoot stage can be pulled out easily. The canes are damaged and also produce a foul odour. The central whorl of leaves dries up in the damaged plants. The number of dead hearts were observed to be considerably reduced compared to the untreated control.

### Example 5: Efficacy of the Combination of Flupyrimin and Chlorantraniliprole

The efficacy of the premix combination of flupyrimin and chlorantraniliprole against Chilo infuscatellus (CHILZO) (early shoot borer) in sugarcane cultivations was evaluated. A suspension concentration formulation of flupyrimin and chlorantraniliprole was applied (CTPR 0.4+Flupyrimin 10 GR). The application was made at an economic threshold (ETL) of 10% dead hearts of the early shoot borer insects and at 25-40 DAP by drip irrigation.

TABLE 6

| | | Active | Use | | | | | | | | | | |
|---|---|---|---|---|---|---|---|---|---|---|---|---|---|
| Tr. | | rate | Rate | Mean of Dead hearts counts (CHILZO) per plot | | | | | | | | | |
| No. | Treatment | (g Al/ha) | (g/ha) | 15 DAA | | 30 DAA | | 45 DAA | | 60 DAA | | 75 DAA | |
| T1 | UTC | NA | NA | 20.00 | a | 33.00 | a | 39.00 | a | 52.00 | a | 41.00 | a |
| T2 | CTPR + Flupyrimin | 235 | 16786 | 3.00 | f | 4.00 | h | 2.00 | h | 6.00 | g | 5.00 | g |
| T3 | CTPR + Flupyrimin | 263 | 18750 | 2.00 | g | 3.00 | i | 1.00 | i | 3.00 | i | 3.00 | i |
| T4 | CTPR + Flupyrimin | 290 | 20715 | 1.00 | h | 1.00 | i | 1.00 | j | 2.00 | j | 2.00 | j |

CTPR: Chlorantraniliprole
UTC: Untreated control

The caterpillars of the shoot borer cause dead hearts in young plants. The young plants with dead hearts formed at shoot stage can be pulled out easily. The number of dead hearts were observed to be considerably reduced compared to the untreated control.

### Example 6: Efficacy Control of Sphenophorus Levis

The efficacy of flupyrimin was determined against adult and the larvae stage of Sphenophorus levis. To evaluate the efficacy of flupyrimin plots with ten Sphenophorus levis adults were populated. Flupyrimin at a concentration of 500 g/L was used to treat the plots by spraying. Each plot received a 10 cm splitted lengthwise suarcane stem piece as feed and accordingly each plot was subjected to treatment conditions as depicted in the table below.

TABLE 7
% Control efficacy of flupyrimin against adult Sphenophorus levis

| | | Active | | Adults efficacy | | |
|---|---|---|---|---|---|---|
| | | ingredient | Rates | control (%) | | |
| No. | Treatment | (g of a.i/ha) | (kg-l/ha) | 1DAA | | |
| 1 | Untreated check | — | — | — | — | — |
| 2 | Flupyrimin | 150 | 0.30 | 46.3 | 75.1 | 97.3 |
| 3 | Flupyrimin | 250 | 0.50 | 61.0 | 80.9 | 100 |
| 4 | Flupyrimin | 300 | 0.60 | 59.5 | 79.5 | 99.1 |
| 5 | Flupyrimin | 500 | 1.00 | 56.9 | 79.9 | 97.3 |

As observed from the table above, an efficient control of adult Sphenophorus levis was obtained immediately on the first day after application of flupyrimin. At 9 DAA an almost complete control of S. levis was obtained.

The efficacy of flupyrimin was determined against the larvae stage of Sphenophorus levis. Accordingly, the larvae bioassay method was residual contact and ingestion. The sugarcane stalks were dipped in a insecticide solution then placed on a papart towel to dry. The sugarcane stalks were placed in glass tubes, then S. levis first stage and last instar lavae were introduced in each tube separately. The mortality achieved was 100% at 1 DAA. The treatments condidtions and the results are depicted in Table 8 below:

TABLE 8
% Control efficacy of flupyrimin against
larvae Sphenophorus levis

| | | Active | | Larvae efficacy |
|---|---|---|---|---|
| | | ingredient | Rates | control (%) |
| No. | Treatment | (g of a.i/ha) | (kg-l/ha) | 1DAA |
| 1 | Untreated check | — | — | — |
| 2 | Flupyrimin | 150 | 0.30 | 100 |
| 3 | Flupyrimin | 250 | 0.50 | 100 |
| 4 | Flupyrimin | 300 | 0.60 | 100 |
| 5 | Flupyrimin | 500 | 1.00 | 100 |

As observed from table 7 and 8 above, an efficient control of the adult and larvae stage of Sphenophorus levis was obtained on treatment with flupyrimin.

We claim:

1. A method of preventing, controlling, or inhibiting insect pests in sugarcane plantations comprising applying flupyrimin to a locus of a sugarcane plant, a plant part, a plant propagation material, or a part thereof.

2. The method as claimed in claim 1, wherein flupyrimin is applied as a composition selected from the group comprising a suspension concentrate, a flowable suspension, flowable concentrate suspension, a granular formulation, an emulsifiable concentrate formulation.

3. The method as claimed in claim 1, wherein flupyrimin is applied in a concentration ranging from 10 g ai/ha to 500 g ai/ha to the locus of a sugarcane plant, plant part, or a growing plant.

4. The method as claimed in claim 1, wherein flupyrimin is applied in a concentration ranging from 50 g ai/ha to 500 g ai/ha to the locus of a sugarcane plant, plant part, or a growing plant.

5. The method as claimed in claim 1, comprising applying flupyrimin and one or more insecticides selected from the group of carbamates, organophosphates, cyclodiene organochlorines, phenylyrazoles, pyrethroids, pyrethrins, neonicotinoids, sulfoximines, butenolides, mesoionics, pyridylidenes, spinosyns, avermectins, milbemycins, alkylhalides, fluorides, borates, oxadiazines, semicarbazones, benzoylureas, diacylhydrazines, pyridine azomethine derivatives, pyropenes, phosphides, cyanides, diamides, meta-diamides and isoxazolines.

6. The method as claimed in claim 5, wherein the diamide insecticide is selected from the group comprising chlorantraniliprole, cyantraniliprole, cyclaniliprole, flubendiamide and tetraniliprole.

7. The method as claimed in claim 6, comprising applying flupyrimin and chlorantraniliprole to a locus of a sugarcane plant, a plant part, a plant propagation material, or a part thereof.

8. The method as claimed in claim 7, wherein the weight ratio of flupyrimin and chlorantraniliprole is ranging from 1:10 to 10:1.

9. The method as claimed in claim 1, wherein the combination of flupyrimin and the diamide insecticide is applied in a concentration ranging from 50 g ai/ha to 500 g ai/ha to the locus of a sugarcane plant, plant part, or a growing plant.

10. The method as claimed in claim 7, wherein flupyrimin is applied in a concentration ranging from 50 g ai/ha to 200 g ai/ha and the diamide insecticide is applied in a concentration ranging from 50 g ai/ha to 200 g ai/ha.

11. The method as claimed in claim 7, wherein flupyrimin is applied in a concentration ranging from 50 g ai/ha to 200 g ai/ha and chlorantraniliprole is applied in a concentration ranging from 50 g ai/ha to 200 g ai/ha.

12. The method as claimed in claim 1, wherein the insect in sugarcane plantation is Sphenophorus levis, Chilo infuscatellus, Diatraea saccharalis, Telchin licus, Heterotermes tenuis, Mahanarva fimbriolata, Migdolus fryanus, and Holotrichia serrata.

13. The method as claimed in claim 12, wherein the insect pests in sugarcane plantations are resistant to conventionally applied insecticides selected from the group consisting of imidacloprid, thiamethoxam, dinetofuran, clothianidin, acetamiprid, nitenpyram, thiacloprid, flupyradifurone, sulfoxaflor and triflumezopyrim.

14. An insecticidal combination comprising flupyrimin and chlorantraniliprole for controlling insect pests in sugarcane plantations are resistant to conventionally applied insecticides.

15. The insecticidal combination as claimed in claim 14, wherein the weight ratio of flupyrimin and chlorantraniliprole is ranging from 1:10 to 10:1.
